(19) United States
(12) Patent Application Publication
(10) Pub. No.: US 2016/0179102 A1
(43) Pub. Date: Jun. 23, 2016

(54) SHARED VALVE UNIT WITH AUTOMATIC SWITCH OF GAS SOURCES ACCORDING TO THE INPUT PRESSURES OF DIFFERENT GAS SOURCES WITH NO NEED TO CHANGE THE NOZZLE

(71) Applicant: NINGBO JINOU HARDWARE CO., LTD., Ningbo City (CN)

(72) Inventor: PAO-CHI Chang, NINGBO (CN)

(21) Appl. No.: 14/844,162

(22) Filed: Sep. 3, 2015

(30) Foreign Application Priority Data
Dec. 19, 2014 (TW) 103222575

(51) Int. Cl. G05D 7/01; B05B 1/30

(52) U.S. Cl. CPC G05D 7/0106; B05B 1/3006

(57) ABSTRACT

A shared valve unit with automatic switch of gas sources according to the input pressures of different gas sources with no need to change the nozzle includes a housing, a differential pressure component and two nozzles, said housing configured with a chamber and a gas flow passage, a gas inlet passage, communicated with the inlet end of said chamber and gas flow passage, a gas outlet passage, communicated with the outlet end of said chamber and gas flow passage, said differential pressure component configured inside said chamber, including a differential pressure diaphragm and a controlling device configured on said differential pressure diaphragm, with its one end configured with a sealing block to seal the gas outlet passage, an elastic component, abutting between one end of said housing and said differential pressure diaphragm, said two nozzles having different diameters, respectively preinstalled inside said gas flow passage and on the outlet end.

### BACKGROUND OF INVENTION

1. Field of the Invention

The present invention relates generally to a gas valve unit, and more particularly to a shared valve unit with automatic switch of gas sources according to the input pressures of different gas sources with no need to change the nozzle.

2. Description of Related Art

For an optimum burning state, the pressure of gas supplied to the burner (a gas burning appliance such as a roaster, a toaster, a heating furnace or a water heater) must be stable. The known controlling method to achieve optimum burning state on a burner using different gas sources is to change the nozzle, i.e., different applicable nozzles are used according to the different gas sources.

For example, the gases used by prior-art burners can be classified into two categories: liquefied petroleum gas (LPG) and natural gas (NG). Liquefied petroleum gas and natural gas have different pressures. The pressure of liquefied petroleum gas is higher than that of natural gas. The diameters of gas nozzles applicable to liquefied petroleum gas and natural gas are also different. Therefore, when the gas source of the burner is changed, in order to achieve optimum burning state, a new applicable nozzle shall be installed to suit liquefied petroleum gas or natural gas. This can be difficult, and may even cause a risk of leakage.

The above problem can be solved by a plurality of nozzles adapted to different gas sources pre-installed on the valve unit supplying combustible gases and an automatic control of the valve unit to switch between different gas sources based on different pressures, with no need to change the nozzle. However, up till now, such a preferred design is not seen in the market.

### SUMMARY OF THE INVENTION

The primary object of the present invention is to provide a shared valve unit with automatic switch of gas sources according to the input pressures of different gas sources with no need to change the nozzle so as to overcome the above-mentioned problem. It is installed with a plurality of nozzles adapted to different gas sources, and can automatically switch between different nozzles based on the different pressures of the input gases. This removes the difficulty to change the nozzle according to different input gases as well as the risk of leakage. Featuring convenience and safety, it indeed has a high practical value.

Thus, to accomplish the above object, the present invention provides a shared valve unit with automatic switch of gas sources according to the input pressures of different gas sources with no need to change the nozzle, comprising a housing, including a base and an upper cap covering the base, with a chamber formed between said base and upper cap, said base extended with a gas flow passage, a gas inlet passage, communicated with the inlet end of said chamber and gas flow passage, a gas outlet passage, communicated with the outlet end of said chamber and gas flow passage; a differential pressure component, configured inside said chamber, including a differential pressure diaphragm, configured on one end of said upper cap corresponding to the base and corresponding to the gas inlet and outlet passages, a controlling device, configured on said differential pressure diaphragm and stretching into the gas outlet passage, with its one end provided with a sealing block to seal the gas outlet passage, an elastic component, abutting between said upper cap and differential pressure diaphragm, such that the sealing block does not seal the gas outlet passage when the differential pressure diaphragm is not subject to gas pressure; a first nozzle, configured inside said gas flow passage; a second nozzle, configured on the outlet end of said gas flow passage, said first nozzle having a smaller diameter than said second nozzle.

### BRIEF DESCRIPTION OF THE DRAWINGS

Following is further detailed descriptions of the present invention based on examples of multiple preferred embodiments in accompany with drawings:

FIG. 1 is a front view of the first preferred embodiment of the present invention.

FIG. 2 is an end view of the first preferred embodiment of the present invention.

FIG. 3 is a sectional view of the first preferred embodiment of the present invention.

FIG. 4 is a schematic view of the action of the first preferred embodiment of the present invention.

FIG. 5 is a schematic view of the action of the second preferred embodiment of the present invention.

FIG. 6 is a sectional view of the third preferred embodiment of the present invention.

FIG. 7 is a perspective view of the pushing plate and elastic component in the third preferred embodiment of the present invention.

### DETAILED DESCRIPTION OF THE INVENTION

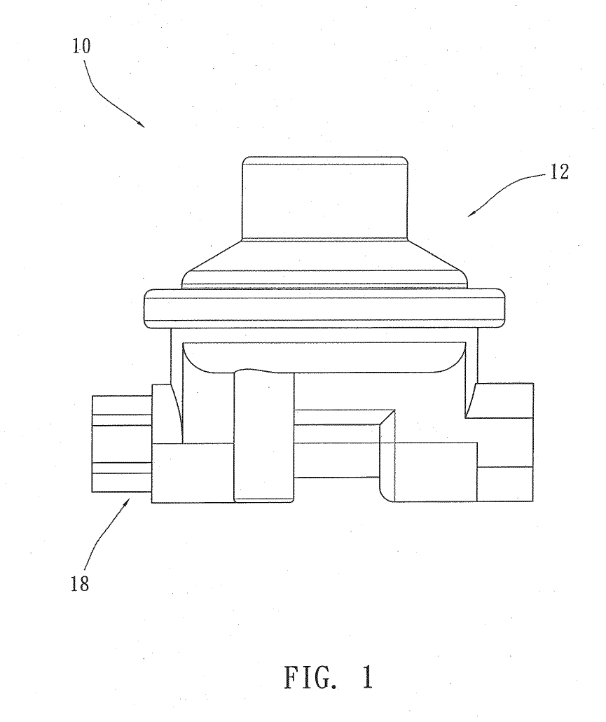

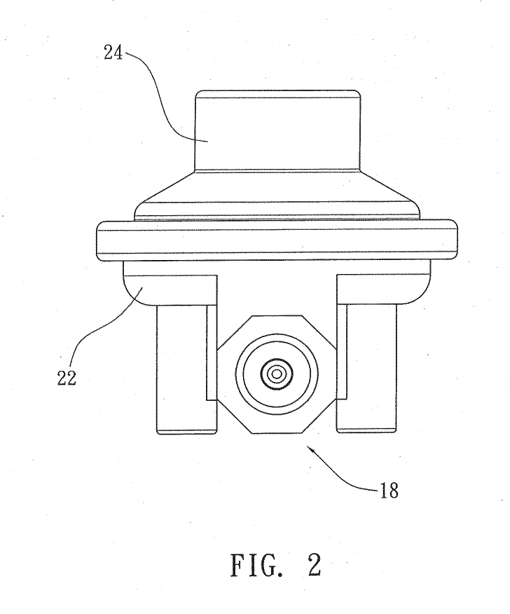

Firstly, referring to FIG. 1 to FIG. 3, the shared valve unit with automatic switch of gas sources according to the input pressures of different gas sources with no need to change the nozzle 10 of the first preferred embodiment of the present invention is provided on one end of a burner (a gas burning appliance such as a roaster, a toaster, a heating furnace or a water heater), to supply gas for operation of the burner, comprising a housing 12, a differential pressure component 14, a first nozzle 16 and a second nozzle 18.

Said housing 12 is formed by a base 22 and an upper cap 24 relatively covering each other, said base 22 and upper cap 24 forming a chamber 26 therebetween. The inside of said base 22 is extended with a gas flow passage 28 having two openings to form an inlet end 30 and an outlet end 32, for input or output of liquefied petroleum gas (LPG) or natural gas (NG). The middle section of said gas flow passage 28 is provided with a reduced segment 33 with a smaller diameter, a gas inlet passage 34, communicated with said chamber 26 and inlet end 30, a gas outlet passage 36, communicated with said chamber 26 and outlet end 32 at a position adjacent to the reduced segment 30. The end of said gas outlet passage 36 communicated with the chamber 26 is configured with a controlling ring 37. The top end of said upper cap 24 is configured with a screw hole 38.

Said differential pressure component 14, configured inside said chamber 26, comprises a differential pressure diaphragm 40, configured on one end of said base 22 connecting to said upper cap 24, formed by a diaphragm 42 with appropriate elasticity (such as a rubber sheet) and a pressure plate 44 abutting each other, a controlling device 46, configured in the center of said differential pressure diaphragm 40 and going through the controlling ring 37 and extending into the gas outlet passage 36, with its one end configured with a sealing block 48; the outer diameter of said sealing block 48 is larger than the inner diameter of said controlling ring 37, such that when said sealing block 48 abutting the inner edge of said controlling ring 37, the communication between the gas outlet passage 36 and the chamber 26 can be blocked; an adjusting component 50, screwed inside said screw hole 38 and able to move up and down, having an adjusting end 52 and an abutting end 54, said adjusting end 52 can be driven by a tool like screwdriver to enable rotation of said adjusting component 50, a pushing plate 56 and an elastic component 58, located between said adjusting component 50 and pressure plate 44, said abutting end 54 is roughly in a conic shape to abut said pushing plate 56, said elastic component 58 being a spring, such that, when the height position of said adjusting component 50 is changed, the pressing force of said elastic component 58 against the differential pressure diaphragm 40 can be adjusted. The default value of the pressing force of said elastic component 58 against the differential pressure diaphragm 40 is a value sufficient for said differential pressure diaphragm 40 to move and enable said sealing block 48 to seal the gas outlet passage 36 when it is pushed by the liquefied petroleum gas pressure.

Said first nozzle 16, being a standard nozzle for liquefied petroleum gas, is configured on said reduced segment 33 at the position corresponding to the outlet end 32, while said second nozzle 18, being a standard nozzle for natural gas, is configured on said outlet end 32. The outer end of said second nozzle 18 just needs a shape that can be clamped by a tool to lock it into the outlet end 32, including, but not limited to, a hexagonal end that can be clamped by a spanner.

Based on this, the shared valve unit with automatic switch of gas sources according to the input pressures of different gas sources with no need to change the nozzle 10 of the present invention can be connected with gas sources with different pressures. The present embodiment uses natural gas or liquefied petroleum gas as an example, but the types of gas sources are not limited. The operations, features, and efficacies are described below:

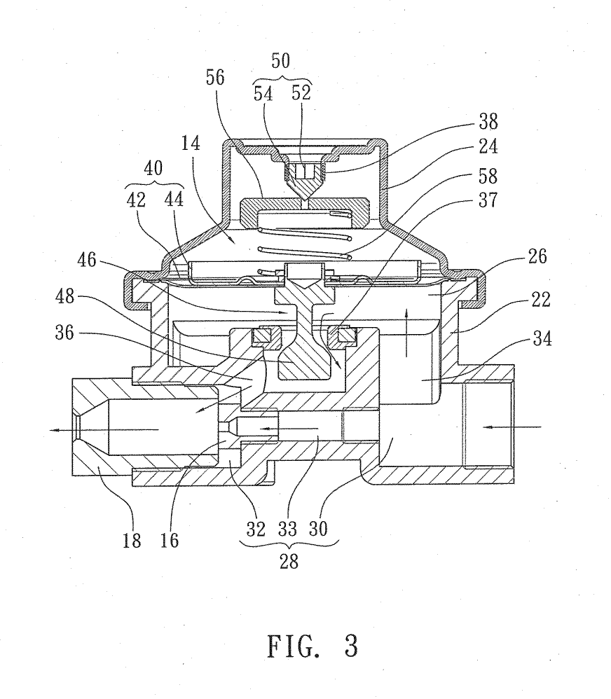

When the input gas of said gas flow passage 28 is natural gas (NG), as the gas pressure is lower than the default value of the pressing force of said elastic component 58 against the differential pressure diaphragm 40, said controlling device 46 has no movement, said gas outlet passage 36 and chamber 26 are communicated with each other, as shown in FIG. 3, the natural gas is ejected out at the same time along two paths through gas flow passage 28, gas inlet passage 34, chamber 26, and gas outlet passage 36, and finally ejected out from said second nozzle 18. The maximum gas output is controlled by said second nozzle 18.

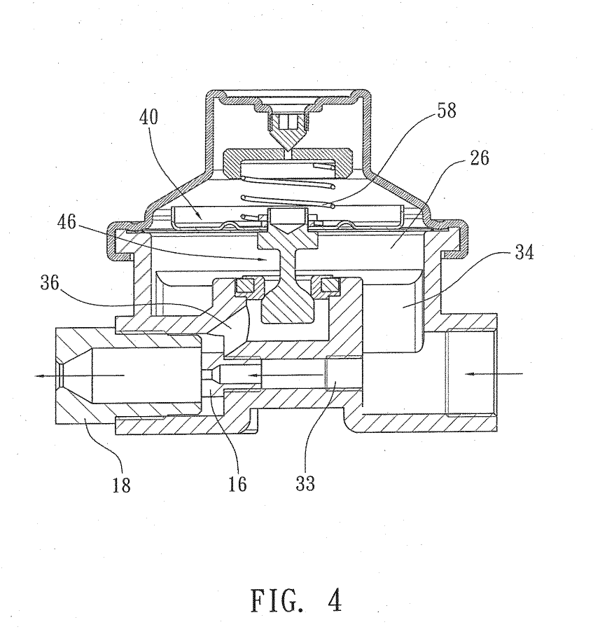

On the other hand, when the input gas of the gas flow passage 28 is liquefied petroleum gas (LPG), as the gas pressure is larger than the default value of the pressing force of said elastic component 58 against the differential pressure diaphragm 40, it will automatically push up the differential pressure diaphragm 40, and cause the controlling device 46 to move upward, and through the sealing block 48 abutting the inner edge of the controlling ring 37, the communication between said gas outlet passage 36 and chamber 26 is blocked, as shown in FIG. 4, thus the liquefied petroleum gas can only go through said gas flow passage 28 and be ejected out from the first nozzle 16. The maximum gas output is controlled by said first nozzle 16.

Moreover, the pressing force of said elastic component 58 against the differential pressure diaphragm 40 can be adjusted simply by rotating the adjusting component 50 from said adjusting end 52 with a tool such as a screwdriver, so that said adjusting component 50 moves up or down.

From the above, it is known that the shared valve unit of the present invention is constructed with two nozzles of different diameters, such as a liquefied petroleum gas nozzle and a natural gas nozzle, and can smartly use the pressure difference between different gas sources to keep the differential pressure diaphragm unmoved or cause it to move, so as to automatically switch between different nozzles for gas output, with no need to change the nozzle according to different input gases, and no risk of gas leakage occurring when changing the nozzle. With obvious convenience and safety, it can overcome the existing problems and therefore has practical values.

It is to be noted that, the gas sources of the present invention use natural gas or liquefied petroleum gas for examples, but their types are not limited. As long as there is a difference of input gas pressure standard between the gas sources, the present invention can be used to automatically switch between different gas sources.

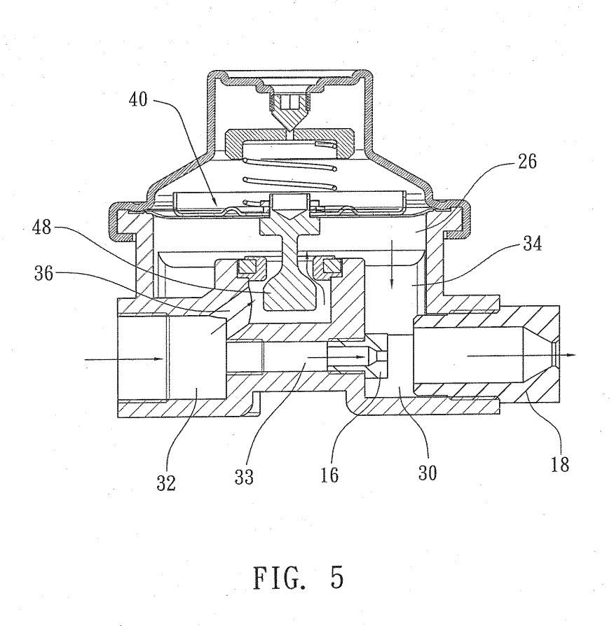

Referring to the second preferred embodiment of the present invention shown in FIG. 5, said first and second nozzles 16, 18 can also be configured inversely on the inlet end 30 of the gas flow passage 28, such that the gas can be input inversely from said outlet end 32, and to enable said differential pressure component 14 to have the same action as described above.

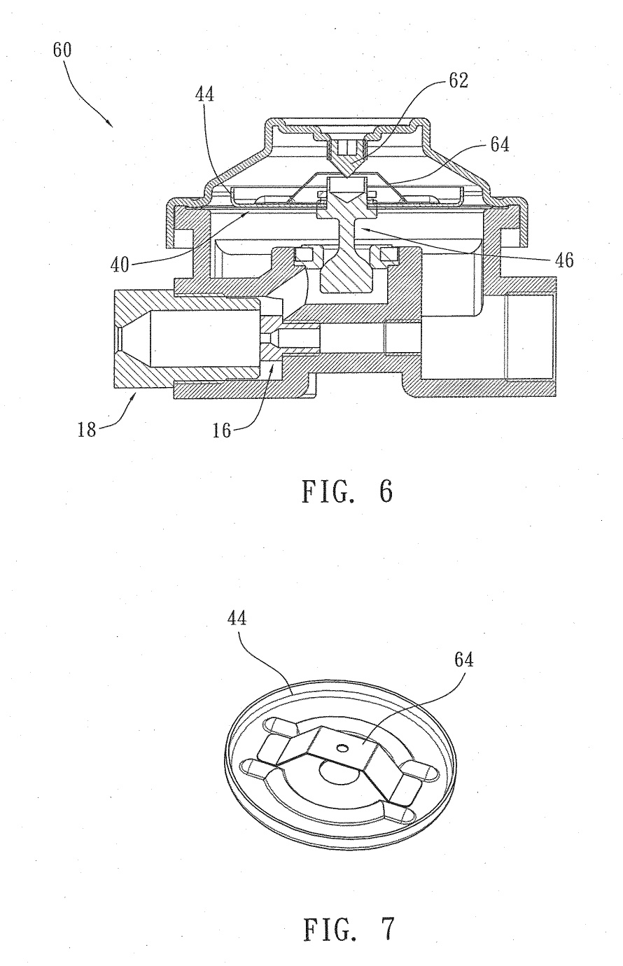

Referring to FIG. 6 and FIG. 7, the shared valve unit with automatic switch of gas sources according to the input pressures of different gas sources with no need to change the nozzle 60 disclosed in the third embodiment of the present invention has a construction roughly the same as said shared valve unit 10, and same components are indicated with same component numerals, with difference in that: with no need for the above-said pushing plate 56, its adjusting component 62 is directly abutting the elastic component 64, and said elastic component 64 is a curved plate spring that can have elastic deformation. Based on this, said shared valve unit 60 can also have the convenient function of the above-stated automatic switching between different gas sources.

What is claimed is:

1. A shared valve unit with automatic switch of gas sources according to the input pressures of different gas sources with no need to change the nozzle, comprising:
a housing, including a base and an upper cap covering the base, with a chamber formed between said base and upper cap, said base extended with a gas flow passage, a gas inlet passage, communicated with the inlet end of said chamber and gas flow passage, a gas outlet passage, communicated with the outlet end of said chamber and gas flow passage;
a differential pressure component, configured inside said chamber, including a differential pressure diaphragm, configured on one end of said upper cap corresponding to the base and corresponding to the gas inlet and outlet passages, a controlling device, configured on said differential pressure diaphragm and stretching into the gas outlet passage, with its one end provided with a sealing block to seal the gas outlet passage, an elastic component, abutting between said upper cap and differential pressure diaphragm, such that the sealing block does not seal the gas outlet passage when the pressure of input gas upon the differential pressure diaphragm is not larger than the elastic force of the elastic component; said gas outlet passage can be communicated with the gas flow passage; and
a first nozzle and a second nozzle, respectively configured inside said gas flow passage and on the outlet end of the gas flow passage, the diameter of said first nozzle being smaller than the second nozzle.

2. The device defined in claim 1, wherein said upper cap can be further configured with a movable adjusting component, and a pushing plate, between said adjusting component and elastic component.

3. The device defined in claim 1, wherein said upper cap can be further configured with a movable adjusting component, with one end of said adjusting component abutting the elastic component, said elastic component being a curved plate spring that can have elastic deformation.

4. The device defined in claim 2, wherein said upper cap is provided with a screw hole, said adjusting component is screwed into the screw hole, including an adjusting end and an abutting end, said adjusting end can be used to drive the rotation of the adjusting component, and said abutting end is abutting the pushing plate.

5. The device defined in claim 3, wherein said upper cap is provided with a screw hole, said adjusting component is screwed into the screw hole, including an adjusting end and an abutting end, said adjusting end can be used to drive the rotation of the adjusting component, and said abutting end is abutting the pushing plate.

6. The device defined in claim 1, wherein said differential pressure diaphragm includes a diaphragm and a pressure plate abutting each other, said controlling device is connected to the diaphragm and the pressure plate, and said elastic component is located between the pushing plate and the pressure plate.

7. The device defined in claim 1, wherein the end of said gas outlet passage communicated with the chamber is configured with a controlling ring, said controlling device goes through the controlling ring, said controlling block can block the communication between the chamber and the gas outlet passage when abutting the controlling ring.

8. The device defined in claim 1, wherein the middle section of said gas flow passage is provided with a reduced segment with a smaller diameter, said gas outlet passage is communicated with said chamber and gas flow passage outlet end at a position adjacent to the reduced segment, said first nozzle is configured on said reduced segment at the position corresponding to the gas flow passage outlet end.

9. The device defined in claim 8, wherein said first nozzle is a standard nozzle for liquefied petroleum gas, and said second nozzle is a standard nozzle for natural gas.
